(19) United States
(12) Patent Application Publication
(10) Pub. No.: US 2005/0195481 A1
(43) Pub. Date: Sep. 8, 2005

(54) Non-electrical demisting method

(76) Inventor: Wu Feng Jui, Tainan Shien (TW)

Correspondence Address: CHARLES E. BAXLEY, ESQ., 90 JOHN STREET, THIRD FLOOR, NEW YORK, NY, 10038, US

(21) Appl. No.: 10/795,066

(22) Filed: Mar. 5, 2004

(51) Int. Cl. G02B 1/00

(52) U.S. Cl. 359/512; 359/507

(57) ABSTRACT

The present invention relates to a non-electrical demisting method, including a mirror and a mirror frame covering on an outer periphery of the mirror frame, wherein the mirror is fixed to inner periphery of the mirror frame. On the outer periphery of the mirror frame is fixed with a heat-conducting element that serves to conduct heat to the mirror, so as to increase temperature of the mirror surface, and thus moistures on the mirror surface can be demisted.

### BACKGROUND OF THE INVENTION

1. Field of the Invention

The present invention relates to a non-electrical demisting method, and more particularly to mirror-demisting method that provides a safe demisting model, wherein the demisting effect is long lasting and can be quickly achieved.

2. Description of the Prior Arts

There are many types of fog-proof mirror have been developed in recent years. The fog-proof mirror is used in bathroom, moistures will be deposited on the mirror surface due to the temperature of the mirror is different from the surrounding temperature, such that mirror will be blurred.

One of the current mirror-demisting methods is shown in FIG. 1, wherein a conventional fog-proof mirror 100 is provided with a mirror frame 200, and a power switch 210 is defined at a predetermined position of the mirror frame 200, and a power cord 300 is connected to the back of the mirror frame 200.

Referring to FIG. 2, which is a cross sectional view of the back of the conventional fog-proof mirror of FIG. 1, wherein a heating cord 400 is arranged on the back of the mirror 100, the power cord 300 has a first end connected to the heating cord 400, and a second end of the power cord 300 is connected to the power source. When the power switch 210 is switched on, the heating cord 400 will be heated and the heat is transmitted to the mirror 100, so as to demist the moistures on the mirror surface.

The above-mentioned conventional demisting method needs electric power to heat the heating cord on the back of the mirror, and power outlet is defined in the bathroom. However, since the bathroom is a damp place, current leakage may be caused when the user inserts the power cord in the outlet. After the power cord is pulled out of the outlet, electrical current also may be leaked out of the open outlet.

The present invention has arisen to mitigate and/or obviate the afore-described disadvantages of the conventional demisting methods for mirror.

### SUMMARY OF THE INVENTION

The primary object of the present invention is to provide a safe and effective demisting method and device that is used to demist the moistures on the mirror surface.

One of the characteristics of the present invention is that on the outer periphery of the mirror frame is fixed with a heat-conducting element which serves to conduct heat to the mirror, so as to increase temperature of the mirror surface, and thus moistures on the mirror surface can be demisted.

Another characteristic of the present invention is that the heat-conducting element can be a liquid-container made of metal or plastic material, on the liquid-container are provided with plural connectors that are connected to a water pipe of an existing shower nozzle in bathroom, or connected to other independent water pipes that can provide hot water. The liquid-container is fixed to the mirror, when the user is using the shower nozzle in bathroom, hot water flows from the water pipe of the shower nozzle into the liquid-container via the connectors, such that the liquid-container is heated, since the liquid-container is fixed to the mirror, the heat will be conducted to the mirror, such that temperature of mirror surface is increased, so as to demist moistures deposited on the mirror surface, furthermore, the shower nozzle connected to liquid-container is able to ease the problem of water temperature fluctuation during a shower.

A third characteristic of the present invention is that the heat-conducting element is a heat-conducting fin, the mirror is fixed to the front of the heat-conducting fin, and on the mirror frame is integrally formed with a water tap that has a front end connected to a water pipe. Hot water flows from the water pipe at the front end of the water tap to the water tap, such that the water tap is heated, and then heat is conducted by from the water tap to the heat-conducting fin, the heat will be finally conducted to the mirror, such that temperature of mirror surface is increased, so as to demist moistures deposited on the mirror surface.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is an assembly view of a conventional fog-proof mirror;

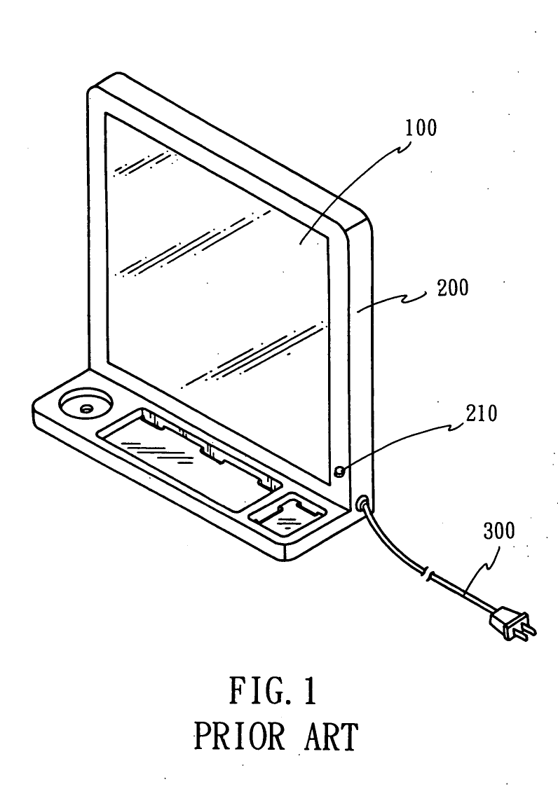

FIG. 2 is a cross sectional view of the back of the conventional fog-proof mirror of FIG. 1;

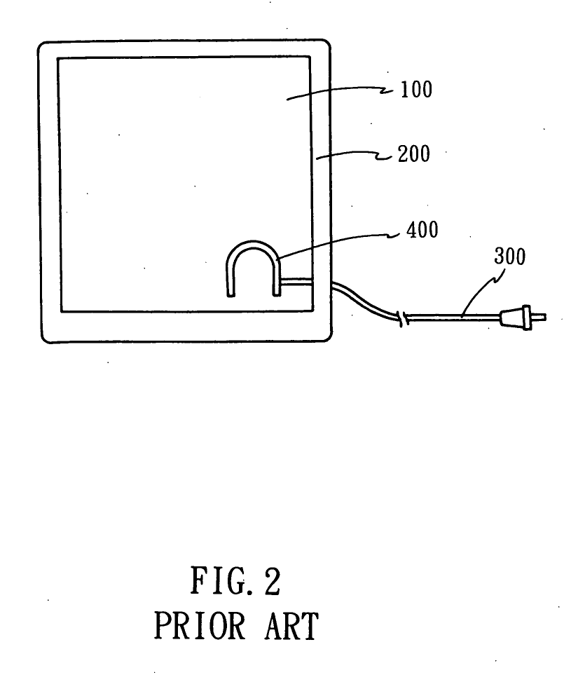

FIG. 3 is an exploded view of a mirror with a demisting device in accordance with a preferred embodiment of the present invention;

FIG. 4 is a perspective assembly view of a mirror with demisting device in accordance with a preferred embodiment of the present invention;

FIG. 5 is another perspective assembly view of the mirror with demisting device in accordance with a preferred embodiment of the present invention;

FIG. 6 is a side assembly view of a mirror with demisting device in accordance with a preferred embodiment of the present invention;

FIG. 7 is an exploded view of a mirror with demisting device in accordance with a second preferred embodiment of the present invention;

FIG. 8 is a perspective assembly view of a mirror with demisting device in FIG. 7;

FIG. 9 is a rear view of a mirror with demisting device of the present invention in FIG. 7;

FIG. 10 is an exploded view of a mirror with demisting device in accordance with a third preferred embodiment of the present invention.

### DETAILED DESCRIPTION OF THE PREFERRED EMBODIMENTS

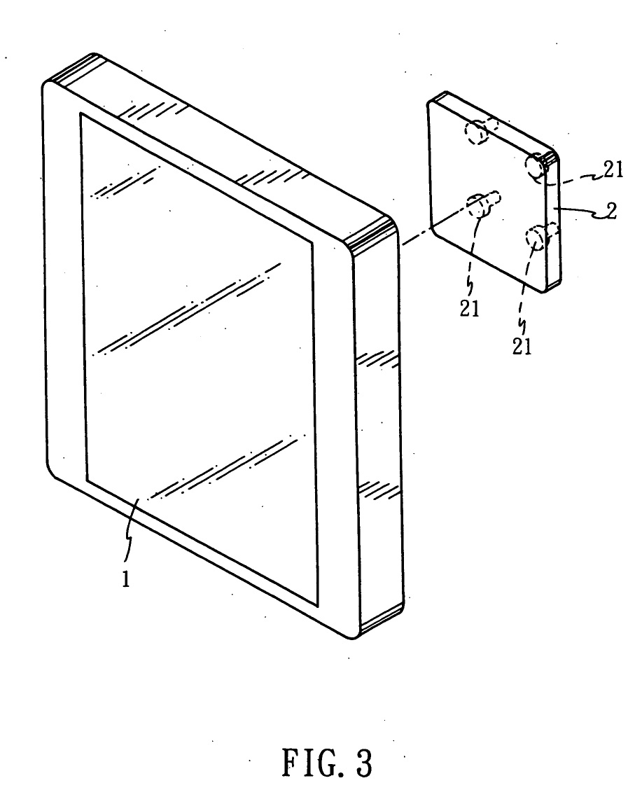

Referring to FIG. 3, which is an exploded view of a mirror with a demisting device in accordance with a preferred embodiment of the present invention, wherein the mirror with demisting device includes a mirror 1, a liquid-container 2 which is made of metal or plastic. On the liquid-container 2 are provided with plural connectors 21 which are connected to pipe of the shower nozzle in bathroom or can be connected to any other pipes that provide hot water.

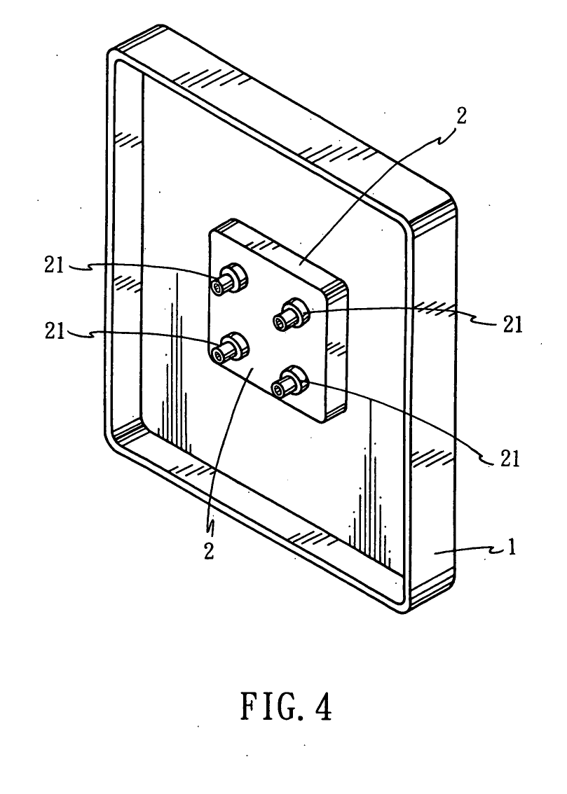

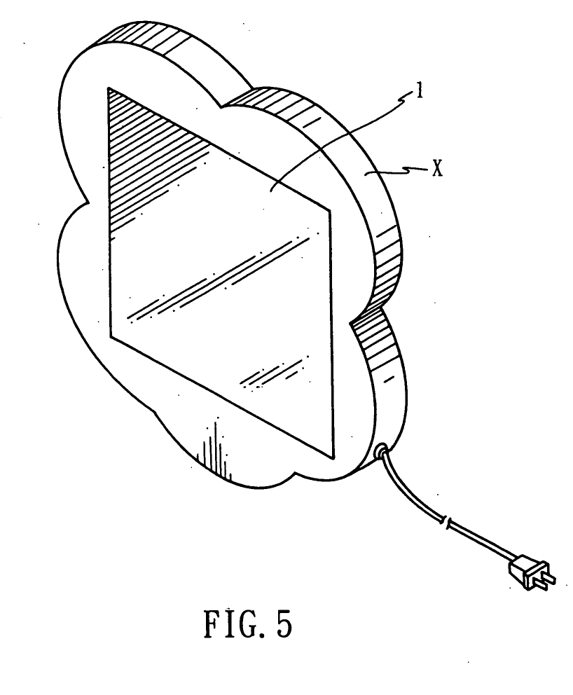

Referring to FIG. 4, which is a perspective assembly view of a mirror with demisting device in accordance with a preferred embodiment of the present invention. In which, the liquid-container 2 is fixed to the mirror 1, such that the connectors 21 on the liquid-container 2 can be connected with pipes that provide hot water. As shown in FIG. 5, which is another perspective assembly view of the mirror with demisting device in accordance with a preferred embodiment of the present invention. In which, on an outer periphery of the mirror 1 can be provided with a nice frame “x”.

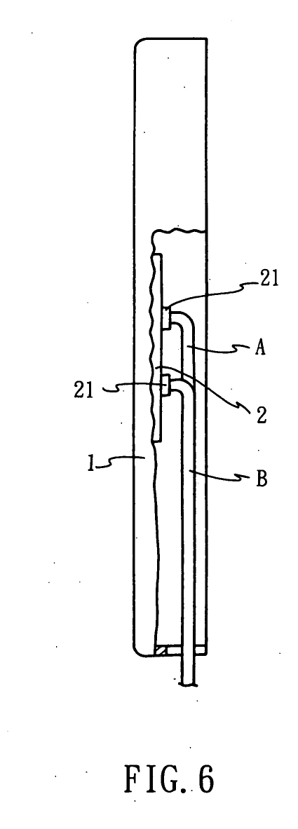

Referring to FIG. 6, which is a side assembly view of a mirror with demisting device in accordance with a preferred embodiment of the present invention, wherein a liquid-container 2 is fixed to the back of the mirror 1. On the liquid-container 2 plural connectors 21 are provided, the front end of each connector 21 can be connected to water pipe of the shower nozzle A in bathroom, or can be connected to any other pipe B which can provide hot water for the liquid-container 2.

Moistures will be deposited on the mirror surface when the temperature of the mirror is different from (higher or lower than) the environmental temperature. When the user is taking a shower with the shower nozzle in bathroom, the hot water will flow from the shower nozzle into the liquid-container 2 via the pipe A so as to heat the liquid-container 2. Since the mirror 1 is fixed to the liquid-container 2, the mirror 1 can be heated by the liquid-container 2, such that the temperature of the mirror surface is increased, and thus achieve a demisting effect. Furthermore, when the shower nozzle is connected to the liquid-container 2, such structure can ease the problem of water temperature fluctuation.

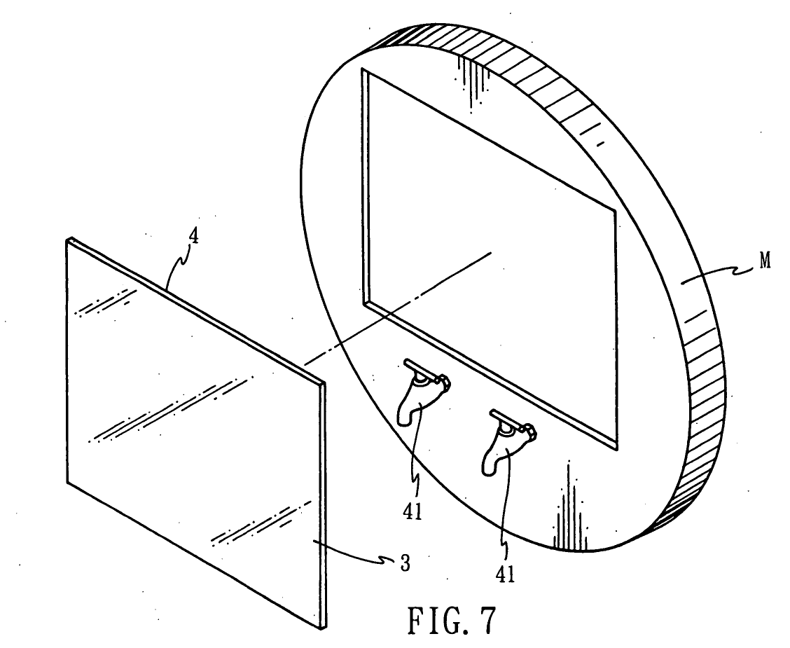

Referring to FIG. 7, which is an exploded view of a mirror with demisting device in accordance with a second preferred embodiment of the present invention, which including: a mirror 3 and a mirror frame M. On the back of the mirror 3 is attached with a heat-conducting fin 4, and at a predetermined position of the mirror frame M is integrally defined with a water tap 41 which is connected to a water pipe.

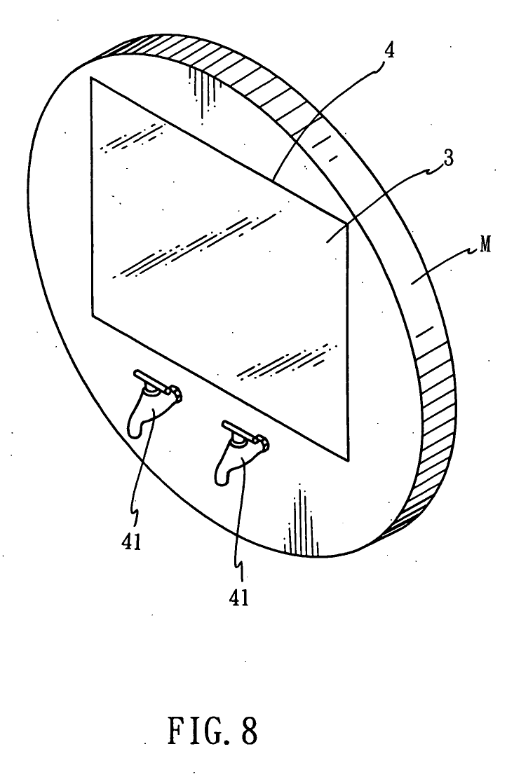

Referring to FIG. 8, which is a perspective assembly view of a mirror with demisting device in FIG. 7, wherein the mirror 3 is fixed in the front of the heat-conducting fin 4. The front end of the water tap 41 is connected to a water pipe C.

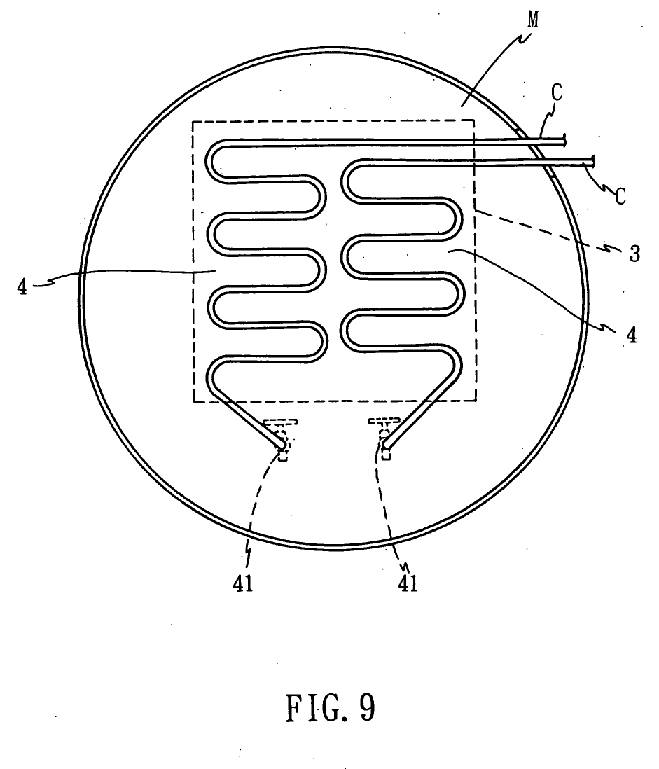

Referring to FIG. 9, which is a rear view of a mirror with demisting device of the present invention in FIG. 7, wherein hot water flows via the water pipe C to the water tap 41, such that the water tap 41 is heated, and the heat is transmitted to the heat-conducting fin 4 from the water tap 41, thus the heat-conducting fin 4 is able to heat the mirror 3, so as to achieve a demisting effect.

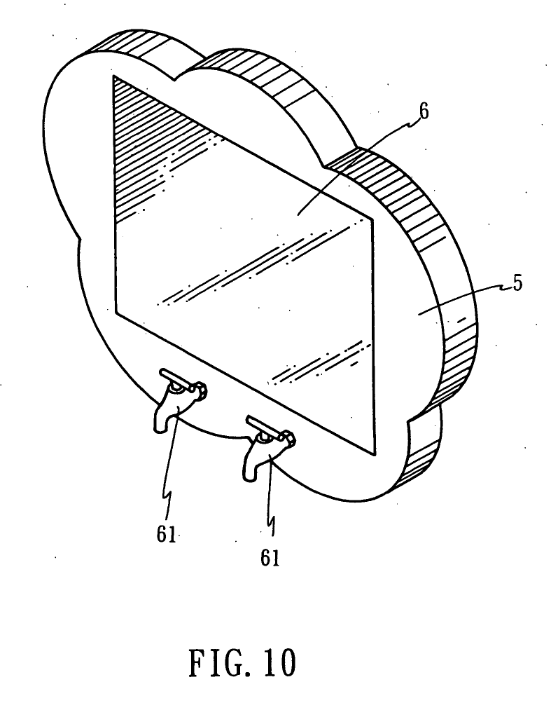

Referring to FIG. 10, which is an exploded view of a mirror with demisting device in accordance with a third preferred embodiment of the present invention. In which, on an outer periphery of the mirror 6 can be covered with a nice frame 5, and at a predetermined position of the frame 5 is provided with a water tap 61, such that the mirror with demisting device in accordance with the present invention is artistically decorated.

It is learned from the above description that the demisting method in accordance with the present invention is to take advantage of the existing hot water pipe to conduct heat to the mirror via liquid-container or water tap, such that the mirror surface is heated and thus a demisting effect can be achieved.

It is also learned from the above descriptions that the non-electrical demisting method has the following advantages:

First, the demisting effect is long lasting and can be quickly achieved, furthermore, demisting method requires no power so as to prevent the danger of using electric instruments in the damp bathroom.

Second, the demisting method of the present invention is to connect the mirror with the existing hot water pipe (or hot water) in bathroom, so as to achieve a perfect demisting effect.

Third, the demisting method according one aspect of the present invention is to heat the back of the mirror by taking advantage of the existing warm or hot water, so as to demist moisture deposited on the mirror surface during a shower.

Fourth, the demisting method of the present invention is able to overcome the danger of using electric instruments over a long period of time in damp surrounding, such that electric power is hopefully taken away from the dressing table in the bathroom. If the demisting device is equipped with liquid-container, the time of hot-or-cold-water supply can be prolonged 3-5 seconds, so as to prevent the temperature fluctuation during a shower. The present invention attaches pipes to the back of mirror, warm or hot water flows into the pipes connected to shower nozzle, so as to demist the moisture on the mirror surface.

While we have shown and described various embodiments in accordance with the present invention, it should be clear to those skilled in the art that further embodiments may be made without departing from the scope of the present invention.

1. A non-electrical demisting method, comprising a mirror and a mirror frame covering on an outer periphery of the mirror frame;
wherein the mirror is fixed to inner periphery of the mirror frame;
on the outer periphery of the mirror frame is fixed with a heat-conducting element which serves to conduct heat to the mirror, so as to increase temperature of the mirror surface, and thus moistures on the mirror surface can be demisted.

2. The non-electrical demisting method as claimed in claim 1, wherein the heat-conducting element can be a liquid-container made of metal or plastic material, on the liquid-container are provided with plural connectors that are connected to a water pipe of an existing shower nozzle in bathroom, or connected to other independent water pipes that can provide hot water;
the liquid-container is fixed to the mirror, when the user is using the shower nozzle in bathroom, hot water flows from the water pipe of the shower nozzle into the liquid-container via the connectors, such that the liquid-container is heated, since the liquid-container is fixed to the mirror, the heat will be conducted to the mirror, such that temperature of mirror surface is increased, so as to demist moistures deposited on the mirror surface, furthermore, the shower nozzle connected to liquid-container is able to ease the problem of water temperature fluctuation during a shower.

3. The non-electrical demisting method as claimed in claim 1, wherein the heat-conducting element is a heat-conducting fin, the mirror is fixed to the front of the heat-conducting fin, and on the mirror frame is integrally formed with a water tap which has a front end connected to a water pipe;
hot water flows from the water pipe at the front end of the water tap to the water tap, such that the water tap is heated, and then heat is conducted by from the water tap to the heat-conducting fin, the heat will be finally conducted to the mirror, such that temperature of mirror surface is increased, so as to demist moistures deposited on the mirror surface.
